(19) United States
(12) Patent Application Publication
(10) Pub. No.: US 2024/0112043 A1
(43) Pub. Date: Apr. 4, 2024

(54) TECHNIQUES FOR LABELING ELEMENTS OF AN INFRASTRUCTURE MODEL WITH CLASSES

(71) Applicant: Bentley Systems, Incorporated, Exton, PA (US)

(72) Inventors: Karl-Alexandre Jahjah, Quebec City (CA); Marc-André Lapointe, Quebec City (CA); Hugo Bergeron, Quebec City (CA); Justin Dehorty, Germantown, MD (US); Arnob Mallick, Austin, TX (US)

(21) Appl. No.: 17/954,694

(22) Filed: Sep. 28, 2022

(51) Int. Cl. G06N 5/02

(52) U.S. Cl. CPC G06N 5/022

(57) ABSTRACT

In example embodiments, techniques are provided for labeling elements of an infrastructure model with classes. The techniques may be implemented by a labeling tool that uses an ML model to create element selections and provides a cycle review mode to speed review within such selections. The labeling tool may further provide for two file loading and a number of visualization schemes to speed comparison of label files and prediction files.

### BACKGROUND

### Technical Field

The present disclosure generally relates to infrastructure modeling and, more specifically, to improved techniques for labeling elements of an infrastructure model with classes.

### Background Information

In the design, construction and/or operation of infrastructure (e.g., buildings, factories, roads, railways, bridges, electrical and communication networks, equipment, etc.), it is often desirable to create infrastructure models. An infrastructure model may maintain a built infrastructure model (BIM) or digital twin (DT) of infrastructure. A BIM is a digital representation of infrastructure as it should be built, providing a mechanism for visualization and collaboration. A DT is a digital representation of infrastructure as it is actually built and is often synchronized with information representing current status, working conditions, position or other qualities.

It is often desirable to label elements of an infrastructure model (e.g., maintaining a BIM or digital twin) as belonging to a particular class. As used herein, the term “element” refers to a record representing an individual infrastructure unit. Elements are often hierarchically arranged according to parent-child relationships (e.g., a parent element may include one or more child elements). A set of elements is typically contained in an infrastructure model to represent the infrastructure collectively. As used herein, the term “class” refers to a category or code to which an element is associated or to which an element belongs. Classes, similar to elements, are often hierarchically arranged according to parent-child relationships (e.g., a parent class may include one or more child subclasses). For example, an infrastructure model of a building may include elements that represent individual components of the building. At least some of the elements may represent assemblies that include sub-elements that make up those assemblies. The elements may belong to classes such as “beam”, “column,” door”, “pipe”, slab”, etc. At least some of the classes may have subclasses. For example, the “slab” class may include subclasses of “floor”, “footing”, pile cap”, “ramp”, etc.

Consistent and accurate class labels allow similar elements to be analyzed together and are therefore vital for various model analysis and analytics types. They are also crucial for model review and maintenance, partitioning models for access control, and various other tasks. However, ensuring consistent and accurate class labels can prove challenging.

One possible way of ensuring class labels are consistent and accurate is to enforce high-quality standards of labeling and nomenclature at the source. Infrastructure models are often constructed by federating data from different data sources, which different teams may manage at different organizations. Different teams frequently use different standards of labeling and nomenclature and follow those standards with differing levels is of diligence and precision. Conceivably, one could compel all teams to use the same standards of labeling and nomenclature and to enforce them diligently. However, in practice, this may prove exceedingly difficult. As a result, considerable manual efforts are often required to review, correct inaccurate, and add missing class labels to elements of infrastructure models. Yet there are currently only limited software tools to assist in such efforts.

Another possible way of ensuring consistent and accurate class labels is to use a trained machine learning (ML) model to predict class labels. A trained PAL model may predict the class of elements based on various features, including geometric features, textual features, and temporal features, among others. Such predictions may then be output in a prediction file. However, while ML models show great promise in this role, there are several impediments to their widespread adoption. Many ML models are trained via supervised learning using labeled datasets (e.g., label files). Such label files typically include elements associated with know-correct class labels that may serve as ground truth during training. An ML model may learn to predict classes accurately if provided with a sufficient number of examples from label files. However, there are currently only limited software tools to assist in labeling elements with classes to produce label files. Further, with existing software tools, it may be challenging to compare label files to predictions (e.g., prediction files) to evaluate if learning is occurring as intended.

Accordingly, there is a need for improved techniques for labeling elements of an infrastructure model with classes to produce infrastructure models with accurate and consistent class labels that may be directly used and/or used in training ML models.

### SUMMARY

In example embodiments, improved techniques are provided for labeling elements of an infrastructure model with classes. The techniques may be implemented by a labeling tool that uses an ML model to create element selections and provides a cycle review mode to speed review within such selections. The labeling tool may provide two file loading and several visualization schemes to speed the comparison of label and prediction files.

In one example embodiment, a labeling tool executing on one or more computing devices displays a visualization of an infrastructure model in a user interface. In response to user input in the user interface, the labeling tool selects one or more elements of the infrastructure model to create a selection. The labeling tool uses an ML model to predict one or more additional elements that share similarities with the selected elements. These one or more additional elements are added to the selection. The labeling tool cycles through at least a set of the elements of the selection, the cycling to repeatedly present in the user interface an element or group of elements of the set of elements and solicit user confirmation that the element or group of elements belongs to a class or user input causing removal of the element or group of elements from the selection. The labeling tool eventually assigns each element of the selection to the class and outputs each of the elements of the selection associated with the assigned class.

In another example embodiment, a labeling tool executing on one or more computing devices loads a label file that, when complete, includes classes of elements in the infrastructure model usable as ground truth to train a machine learning (ML) model. The labeling tool also loads a prediction file that includes an ML model predictions of the classes of elements in the infrastructure model. The labeling tool displays in its user interface a visualization of the infrastructure model, indications of numbers of elements for one or more classes included in the label file, and indications of numbers of elements for one or more classes included in the prediction file. In response to user input in the user interface, the labeling tool selects an element of the infrastructure model and assigns to the selected element or to a group of elements that includes the selected element, a class. The labeling tool then updates the displayed indications of numbers of elements for each class based on changes made in the assigning and outputs a label file that includes the changes made in the assigning.

It should be understood that various additional features and alternative embodiments may be implemented other than those discussed in this Summary. This Summary is intended simply as a brief introduction to the reader and does not indicate or is imply that the examples mentioned herein cover all aspects of the disclosure or are necessary or essential aspects of the disclosure.

### BRIEF DESCRIPTION OF THE DRAWINGS

The description below refers to the accompanying drawings of example embodiments, of which:

FIG. 1 is a high-level block diagram of at least a portion of an example software architecture in which improved techniques are provided for labeling elements of an infrastructure model;

FIG. 2 is a flow diagram of an example sequence of steps that may be implemented by a labeling tool to label elements of an infrastructure model with classes;

FIG. 3 is an excerpt from an example prediction file;

FIG. 4 is a screenshot of an example user interface of a labeling tool showing a first visualization option;

FIG. 5 is a screenshot of an example user interface of a labeling tool showing a second visualization option;

FIG. 6 is a screenshot of an example user interface of a labeling tool showing a third visualization option;

FIG. 7 is a screenshot of an example user interface of a labeling tool showing an ML model-enabled selection feature with an initial selection;

FIG. 8 is a screenshot of an example user interface of a labeling tool showing the addition of elements to a selection by an ML model-enabled selection feature; and

FIG. 9 is a screenshot of an example user interface of a labeling tool in which a cycle selection feature may repeatedly cycle through a set of elements.

### DETAILED DESCRIPTION

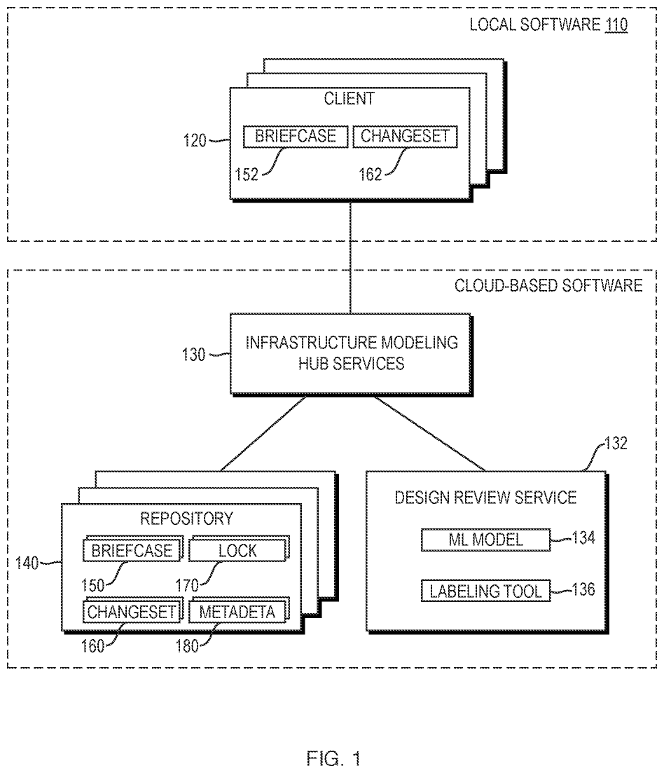

FIG. 1 is a high-level block diagram of at least a portion of an example software architecture in which improved techniques are provided for labeling elements of an infrastructure model. The architecture may be divided into client-side software 110 is executing on one or more computing devices arranged locally (collectively “client devices”) and cloud-based services software 112 executing on one or more remote computing devices (“cloud computing devices”) accessible over the Internet. Each computing device may include processors, memory/storage, a display screen, and other hardware (not shown) for executing software, storing data and/or displaying information. The client-side software 110 may include client software applications (or simply “clients”) 120 operated by users. The clients 120 may be of various types, including desktop clients that operate directly under an operating system of a client device and web-based client applications that operate within a web browser. The clients 120 may be mainly concerned with providing user interfaces that allow users to create, modify, display and/or interact with infrastructure models. One specific type of infrastructure model may be the iModel® infrastructure model.

The cloud-based software 112 may include infrastructure modeling hub services (e.g., iModelHub™ services) 130 and other services software that manage repositories 140 that maintain the infrastructure models. The clients 120 and the infrastructure modeling hub services 130 may utilize a built infrastructure schema (BIS) that describes the semantics of data representing infrastructure, using high-level data structures including using elements, models, and relationships. The BIS may utilize (be layered upon) an underlying database system (e.g., SQLite) that handles primitive database operations, such as inserts, updates and deletes of rows of tables of underlying distributed databases (e.g., SQL databases). The database system may utilize an underlying database schema (e.g., a DgnDb schema) that describes the actual rows and columns of the tables. Elements, models and relationships may be maintained using rows of tables, which store related metadata.

Briefcases and changesets may be utilized by clients 120 and infrastructure modeling hub services 130 to enable multiple versions and concurrent operation. A briefcase is a particular instance of a database that, when used as a constituent database of a repository 140, represents a materialized view of the information of a specific version is of the repository. Initially, an “empty” baseline briefcase may be programmatically created. Over time the baseline briefcase may be modified with changesets, which are persistent electronic records that capture changes needed to transform a particular instance from one version to a new version.

Infrastructure modeling hub services 130 may maintain briefcases 150 and a set of accepted changesets 160 (i.e., changesets that have been successfully pushed) in a repository 140. The infrastructure modeling hub services 130 may also maintain locks 170 and associated changeset metadata 180 in the repository 140. When a client 120 desires to operate upon an infrastructure model, it may obtain the briefcase 150 from a repository 140 closest to the desired state and those accepted changesets 160 from the repository 140 that, when applied, bring that briefcase up to the desired state. To avoid the need to constantly access the repositories 140, clients may maintain a local copy (a local instance) 152.

When a client 120 desires to make changes to the infrastructure model, it may perform operations on rows of tables of its local copy. The client 120 records these database operations and eventually bundles them to create a local changeset 162. Subsequently, the client 120 may push the local changeset 162 back to infrastructure model hub services 130 to be added to the accepted changesets 160 in a repository 140.

The infrastructure modeling hub services (e.g., iModelHub™ services) 130 may interact with several other services in the cloud that perform information management and support functions. One such service may be a design review service 132 that enables users to securely review and share infrastructure models and perform tasks such as virtual walkthroughs, querying model information, and analyzing property data. In one implementation, the design review service 132 may be the Projectwise® Design Review service.

The design review service 132 may require consistent and accurate class labels for servicing queries and analyzing property data. The design review service 132 may also require consistent and accurate class labels for training an ML model 134 that can be used to predict other class labels. The design review service 132 may include an ML is model 134 adapted to learn to predict the class of elements of an infrastructure model from one or more label files that provide ground truth and to output such predictions as a prediction file. The class information in the prediction file may be displayed by the design review service 132 and provided in one or more changesets back to a repository 140 to create a new version of the infrastructure model.

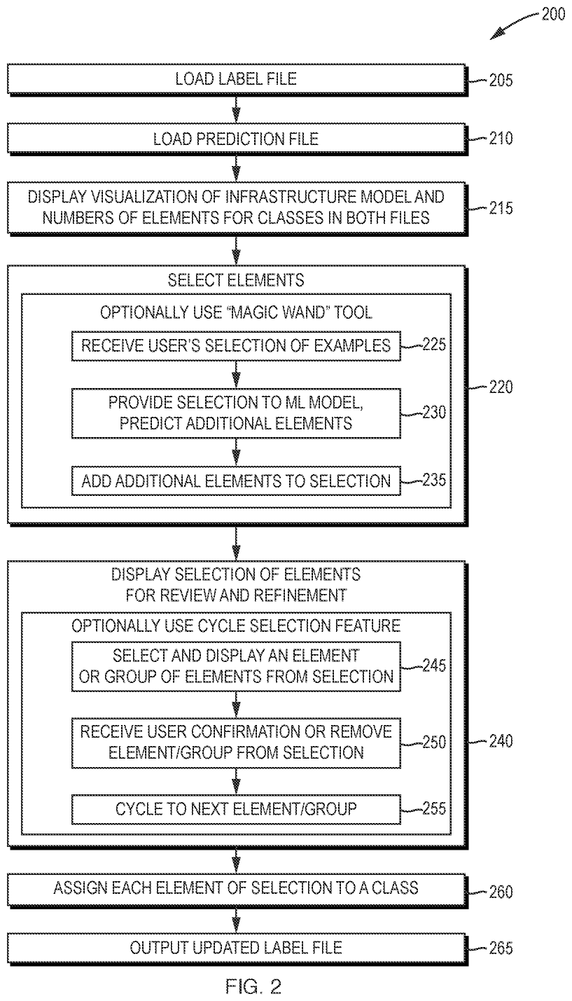

To produce the class labels, the design review service 132 may employ a labeling tool 136 that implements improved techniques for labeling elements of an infrastructure model with classes. FIG. 2 is a flow diagram of an example sequence of steps 200 that may be implemented by the labeling tool 136. The steps may assume the infrastructure model has already been selected and its relevant briefcase 150 and changesets 160 up to the desired state retrieved. At step 205, the labeling tool 136 loads a label file for the infrastructure model. The label file may be associated with changesets 160 for the desired state (e.g., by a changeset identifier(ID)). The label file may be a .json file that lists each element of the infrastructure model identified by an element ID (“dgnElementID”) and a vector of one or more classes (“className”). A class may be associated with a level of a class hierarchy, such that each class may have zero or more parent classes. Initially, the label file may be missing classes for at least some elements (e.g., be partially or entirely empty) and/or may include at least some inaccurate class labels. Through the sequence of step 200, the missing and/or inaccurate class labels may be added/corrected.

In some cases, the label file may be set initially to include ML model predictions obtained from a prediction file. Such ML model predictions may seed class labels with initial values that can be refined and corrected through the sequence of steps 200. In other cases, the label file may be set to include class labels from another existing label file associated with a previous version of the infrastructure model (e.g., associated with an older changeset). Labels for objects that have been modified may be deleted or flagged to facilitate correction using the sequence of step 200.

At step 210, the labeling tool 136 loads a prediction file. Similar to the labeling file, the prediction file may be associated with changesets 160 up to the desired state. The prediction file may be a .json file that lists each element of the infrastructure model is identified by an element ID (“dgnElementID”), a vector of one or more classes (“className”) predicted by the ML model 134, and prediction confidence (“probability”) of each class. The prediction confidence of each class for an element may sum to a given value (e.g., 1), and predictions with confidence at or below a given threshold may be omitted. The prediction file may also include information about the ML model 134 used to create the predictions.

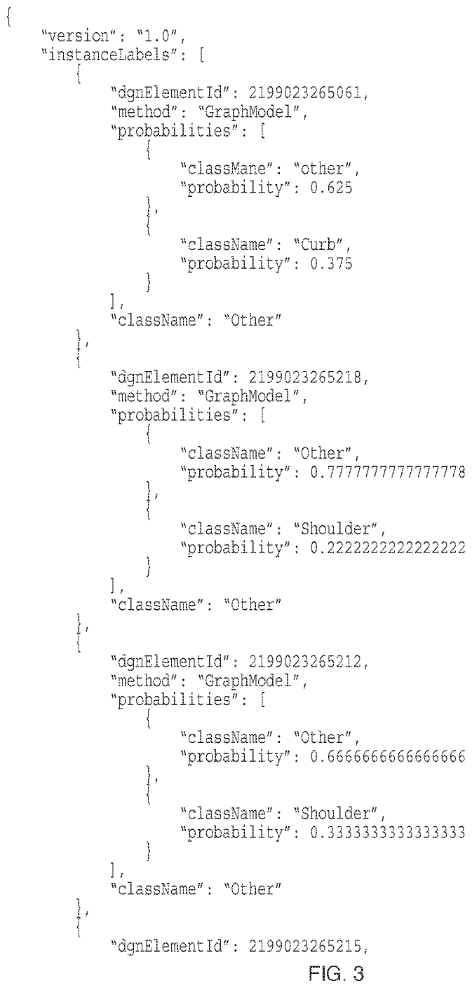

FIG. 3 is an excerpt 300 from an example prediction file. The excerpt 300 shows several example element IDs (“dgnElementIDs”) and their accompanying vector of classes (“className”) and prediction confidences (“probability”). A label file may be similarly formatted, simply lacking prediction confidence.

As part of steps 205-210, or as needed, the labeling tool 136 may also load a label definition file that is shared between the label file and the prediction file. Sharing the same label definition file may indicate the two files are used with the same ML task. The label definition file includes a definition of a set of classes that may be predicted by the ML model 134. In some cases, the set of classes in the label definition file may initially be dynamically created from an infrastructure model, for example, based on a database query (e.g., an ECSQL query) performed by the underlying database system. The classes may be hierarchically arranged according to parent-child relationships, wherein the class name is unique within the context of a parent class. The set of classes and their hierarchical arrangement can be fixed (i.e., no new classes can be added, and the class hierarchy cannot be changed) or extendable (i.e., new classes can be added and the class hierarchy changed) in response to labels provided in the user interface of the labeling tool 136.

At step 215, the labeling tool 136 displays in its user interface a visualization of the infrastructure model, indications of numbers of elements for one or more classes included in the label file, and numbers of elements for one or more classes included in the prediction file. The indications of numbers of classes may include indications of total numbers of elements of each class included in the files, numbers of elements of each class within a user selection of the elements included in the files, or other types of numeric class information. In some cases, the number of elements may be affected by element visibility within the visualization, for example, to only count visible elements. A wide variety of other alternatives are also possible.

The visualization of the infrastructure model may be responsive to visibility, color coding and other visual indicia controls. In response to user input, the elements' visibility may be independently adjusted by class for both files. Such adjustment may be binary (e.g., visible/invisible) or variable (e.g., 90% visible). The color coding and other visual indicia may provide information about class labels included in the files according to several different visualization options. Many of these visualization options rely on a user selection of one of the files, and the selected file often affects the visualization state of the infrastructure model. That is, while two files may be loaded into the labeling tool 136, for many visualization options, only the selected one of the files will affect the visualization state of the infrastructure model. However, some visualization options may utilize both files to affect the visualization state to provide differential displays.

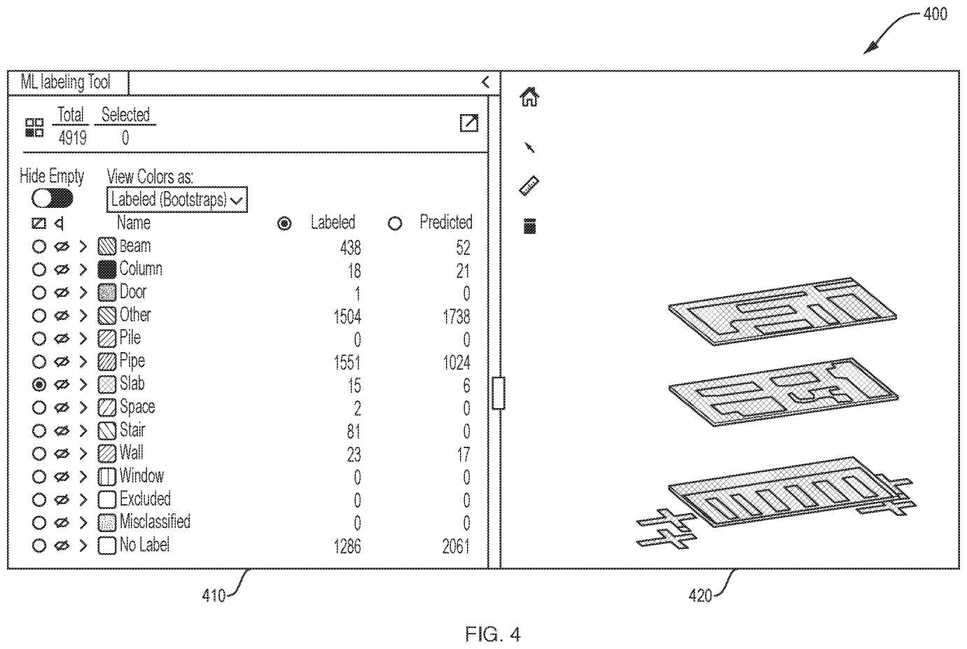

In a first visualization option, the color or other visual indicia indicates class in the selected file. For example, each class may be displayed in a different color or with other visual indicia. The color or other visual indicia of classes may be predefined or user modifiable within the user interface of the labeling tool 136. Multiple classes may be represented with the same color or other visual indicia to group them visually. FIG. 4 is a screenshot 400 of an example user interface of the labeling tool 136 showing the first visualization option. In the left-side portion 410 of the user interface, there are indications of the numbers of elements for each class included in the label file and prediction file, for example, 438 and 52 “beam”, 18 and 21 “column”, 1 and 0 “door”, etc. in the label file and prediction file, respectively. Also, in the left-side portion 410, is an indication of color associated with each class according to the color coding. In the right-side portion 420 of the user interface, there is a visualization of the infrastructure model that includes the color coding on elements. Differential visibility controls may be provided to enable easier viewing of elements of the infrastructure model by class. In this example, in is response to user input, “slab” has been selected, and the visualization of the infrastructure model only shows elements associated with the “slab” class in the selected file, which is the label file in this case.

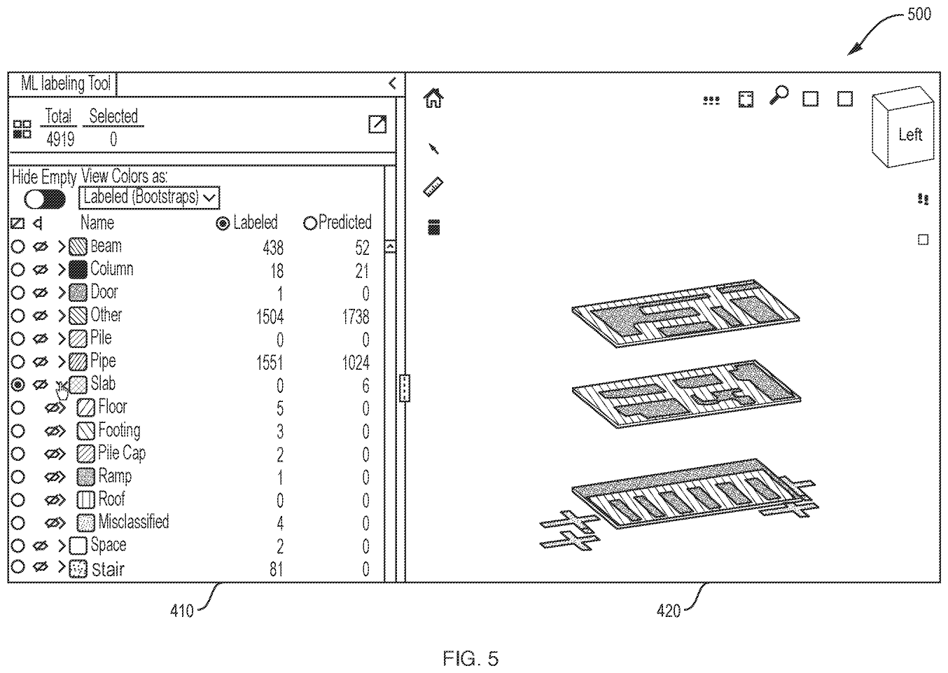

In a second visualization option, the color or other visual indicia may indicate class hierarchy in the selected file. For example, the classes included in the two files may be arranged by hierarchy, so parent classes are expandable to show their child classes and collapsible to hide their child classes in response to user input. When a parent class is collapsed, the color or other visual indicia of classes of each child classes may be set to that of the parent class. When a parent class is expanded, each child class may be set to its different color or other visual indicia. Such an arrangement may allow a user to spot inaccurate class labels at different levels of detail quickly. FIG. 5 is a screenshot 500 of an example user interface of the labeling tool 136 showing the second visualization option. In the left-side portion 410 of the user interface, the user has selected to expand the “slab” class to show its child classes, including “floor”, “footing”, “pile-cap”, etc. Since the parent class is expanded, each child class is displayed in the visualization of the infrastructure model in the right-side portion 420 of the user interface in its different color. If the user should select to collapse the “slab” class, each child class will be shown in the color assigned to the “slab” class.

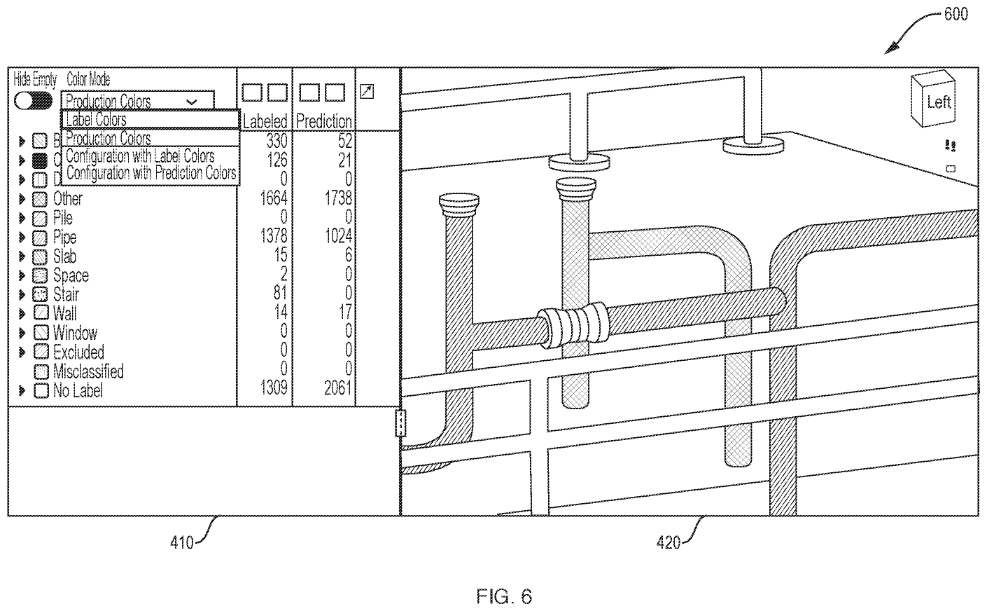

In a third visualization option, which may be only applicable when the prediction file is selected, the color or other visual indicia may indicate confidence in the prediction of a class. Such visualization option may take multiple different modes or forms. For example, in one mode, elements of the infrastructure model are displayed in a color that indicates the class prediction for which the ML model 134 has the highest confidence. In another mode, when a user selects a specific class in the user interface, each element associated with such class is displayed in a color indicating the relative confidence in the class prediction. Such modes may allow a user to rapidly spot elements for which the ML model 134 is uncertain. FIG. 6 is a screenshot 600 of an example user interface of the labeling tool 136 showing the third visualization option. In this example, each element of the infrastructure model is displayed in the visualization of the infrastructure model in the right-side portion 420 of the user interface in a color indicating the class prediction for is which the ML model 134 has the highest confidence.

In a fourth visualization option, which may utilize class information from both files, the color or other visual indicia may indicate differences in class between the label file and the prediction file. Such visualization option may take multiple different modes or forms. For example, in one mode, elements may be colored if they are associated with the same class in both files.

It should be understood that a wide variety of other visualization options may also be provided that utilize class information from a selection file, from both the label file and the prediction file, and/or from other sources. The above visualization options should be understood as examples of the wide variety of other visualization options that may be provided.

At step 220, in response to user input in its user interface, the labeling tool 136 selects one or more elements of the infrastructure model. A variety of forms of element selection may be provided. Single element selection may be performed in response to user input selecting an individual element. For example, if a user “clicks on” a given element in the visualization of the infrastructure model, that element may be selected. Multiple element selection may also be performed in response to user input. For example, the user may “click on” multiple elements in the visualization of the infrastructure model, or the user may “click on” the name of a given class, where all elements associated with that class may be selected. Multiple element selection may follow a class hierarchy (e.g., when a parent class is selected, all elements associated with its child classes may be selected).

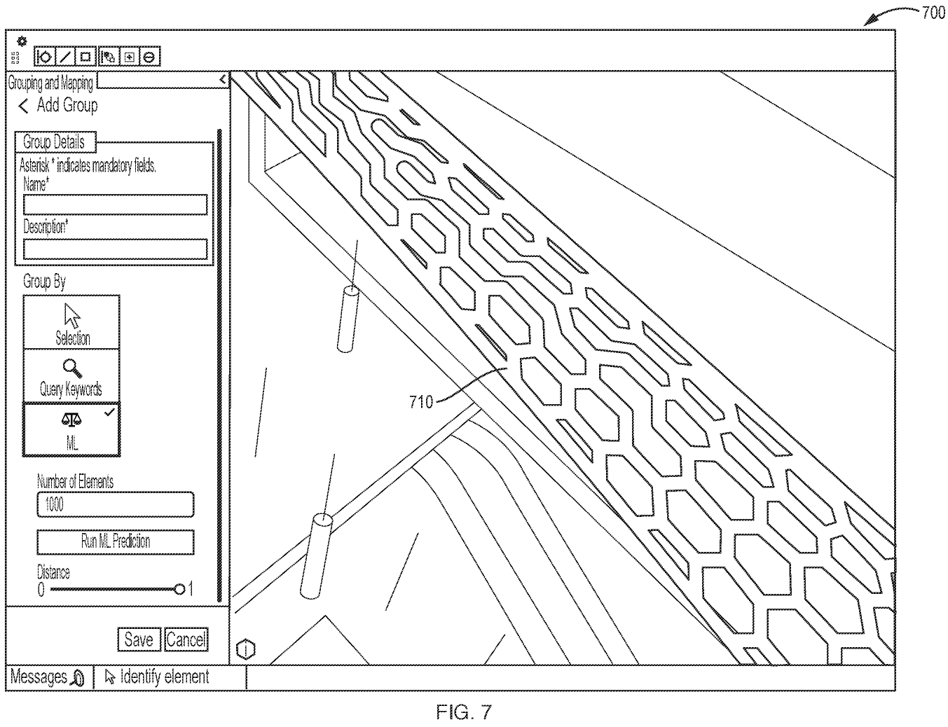

An ML model-enabled selection feature (also referred to as a “magic wand” tool) may be provided by the labeling tool 136 to assist with multiple element selection. The ML model-enabled selection feature may leverage the ML model 134 to expand a selection of elements chosen by a user by adding additional elements predicted by the ML model 134 that share similarities with the selected elements. In more detail, at sub-step 225, the ML model-enabled selection feature receives elements selected in response to user input that serves as positive examples and creates an initial selection. Such is selection may be formed from one or more single element selections and/or multiple element selections, as discussed above. Optionally, as part of sub-step 225, the ML model-enabled selection feature may also receive elements selected in response to user input to serve as negative examples. Such negative examples may represent elements that should not be included in a final selection. FIG. 7 is a screenshot 700 of an example user interface of the labeling tool 136 showing an ML model-enabled selection feature with an initial selection 710.

At sub-step 230, the ML model-enabled selection feature of the labeling tool 136 provides the selection (and optionally the negative examples) to the ML model 134, which predicts additional elements that share similarities with the selected elements. The number of additional elements the ML model 134 is tasked to predict may be user-selectable (e.g., provided in a field or indicated by a slider in the user interface), automatically determined (e.g., set to an inflection point or other statistical threshold of a similarity distribution calculated by the ML model 134), or based on a combination of user-selected and automatically-determined information (e.g., an automatically determined number adjusted by the user). Referring to the example in FIG. 7, a user may enter a number (here, 1000) in a field 710 to indicate the number of additional elements the ML model 134 is tasked to predict.

The ML model 134 may predict additional elements that share similarities using various techniques. In one implementation, a prototype network is employed. A neural network may learn a non-linear mapping that transforms element features into embeddings. The neural network may be trained to distribute the embeddings in multi-dimensional embedding space, such that the distance between the embeddings is meaningful to the similarity between elements. Embeddings may be used to determine prototypes, and a prototype may be a mean or a probabilistic distribution. An infrastructure model's elements may be similar by being within a distance from a prototype. Further details of the use of prototype networks may be found in U.S. patent application Ser. No. 17/314,735, titled “Classifying Elements and Predicting Properties in an Infrastructure Model through Prototype Networks and Weakly Supervised Learning.”

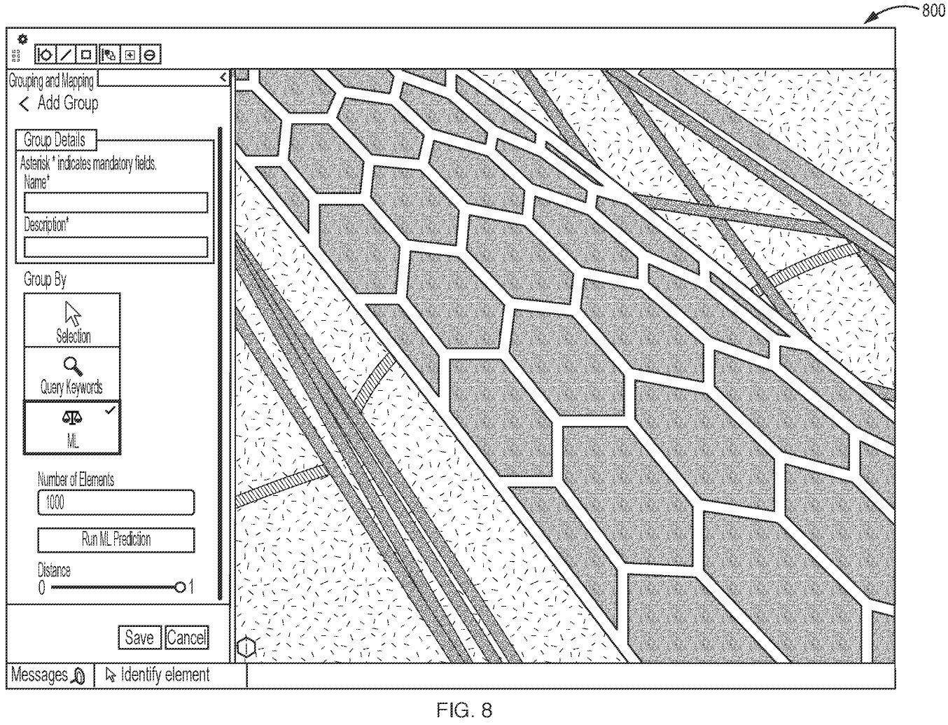

At sub-step 235, the ML model-enabled selection feature of the labeling tool 136 adds the additional elements returned by the ML model 134 to the selection. FIG. 8 is a screenshot 800 of an example user interface of the labeling tool 136 showing the addition of elements (here, 1000) to the selection by the ML model-enabled selection feature.

At step 240, the labeling tool 136 displays the selection of elements in the user interface to a user for review and refinement. The selection may be displayed in various ways, and elements are removed from the selection in response to various user input forms. In one implementation, the labeling tool 136 may provide a cycle selection feature that cycles through at least a set of the elements of the selection, repeatedly presenting in the user interface an element or group of elements of the set and soliciting user confirmation that it should remain in the selection (since it belongs to the class) or user input indicating it should be removed from the selection (since it does not belong to the class). In more detail, at sub-step 245 the cycle selection feature selects and displays an element or a group of elements of the selection. Multiple elements may be grouped and treated collectively based on one or more predefined rules that place elements that share characteristics within the same group. Such grouping may reduce the number of individual states that are cycled through. The shared characteristics may include an identical or similar value of a metadata field, a polygon mesh that is the same or within a predetermined threshold of difference, a bounding box that is the same or within a predetermined threshold of difference, or another measure of commonality. When the cycle selection feature presents a group of elements, it may show all elements of the group or only a selected element of the group that is representative of the group as a whole. The element (or selected representative element) may be focused upon (e.g., centered upon) in the visualization of the infrastructure model and related metadata displayed to the user to enable evaluation of its class.

At sub-step 250, the cycle selection feature receives user confirmation that the element or group of elements should remain in the selection or user input, causing the removal of the element or group of elements from the selection. The confirmation that the element or group of elements should remain in the selection may be implicit (e.g., the is user takes no action and advances the cycling to the next element or group of elements) or involve direct user input. The user input causing removal may simply remove the element or group of elements without specifying their correct class or assigning them a correct class that the user in the user interface indicates. The assigned class may be a class already in the label definition file or a new class assigned and added to the label definition file as part of this operation.

At sub-step 255, the cycle selection feature cycles to the next element or group of elements of the selection in response to user input (e.g., a forward arrow key press). Such cycling may be sequential (i.e., advancing one-by-one), periodic (i.e., advancing skipping over a given number of intervening elements or groups), or random (e.g., advancing to a randomly selected element or group).

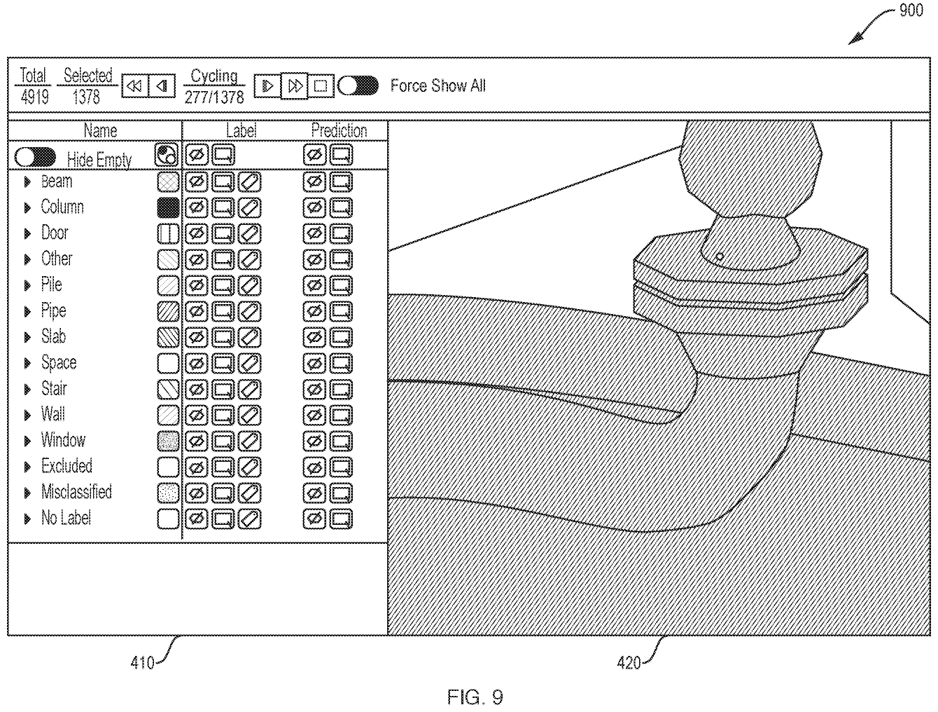

Sub-steps 240-255 may be repeated to cycle through selected elements. FIG. 9 is a screenshot 900 of an example user interface of the labeling tool 136 in which a cycle selection feature may repeatedly cycle through a set of elements. Since a selection may be quite large (e.g., include 1000s of elements), even with grouping enabled, the operation of cycling through all the elements may take a significant amount of time. To address this, it is envisioned that cycling may be terminated before all elements are examined (i.e., the set of elements cycled through is less than all the elements of the selection). It may be assumed that if a number of the elements of the selection belong to the class, the rest of the elements of the selection will also belong to the class and need not be explicitly reviewed. Given a number verified to belong, the cycle selection feature may calculate (e.g., using Bayesian inference) a probability that the remaining elements of the selection belong to the class and display an indication of such probability. When using Bayesian inference to calculate such probability, a user-configurable label quality threshold may be used, indicating the desired class label accuracy level.

At step 260, the labeling tool 136 assigns each element of the selection to the class. For each element, the assignment may generate a new class label or update an existing class label in the label file.

Finally, at step 265, the labeling tool 136 outputs the updated label file. The label is file 136 may be stored for later use or used immediately. One use of the label file 136 may be to train the ML model 134 using supervised learning, creating a new ML model 134. After that, the new ML model 134 may be used to produce a new prediction file, and the steps 200 of FIG. 2 repeated, utilizing the improved predictions in the labeling workflow and thereby providing incrementally improving results.

In summary, the present disclosure presents improved techniques for labeling elements of an infrastructure model with classes. It should be understood that various adaptations and modifications may be made to the techniques. In general, it should be remembered that functionality may be implemented using different software, hardware and various combinations thereof. Software implementations may include electronic device-executable instructions (e.g., computer-executable instructions) stored in a non-transitory electronic device-readable medium (e.g., a non-transitory computer-readable medium), such as a volatile memory, a persistent storage device, or another tangible medium. Hardware implementations may include logic circuits, application-specific integrated circuits, and/or other types of hardware components. Further, combined software/hardware implementations may include both electronic device-executable instructions stored in a non-transitory electronic device-readable medium and one or more hardware components. Above all, it should be understood that the above description is meant to be taken only by way of example.

What is claimed is:

1. A method for labeling elements of an infrastructure model with classes, comprising:
displaying a visualization of the infrastructure model in a user interface of a labeling tool executing on one or more computing devices;
selecting, in response to user input in the user interface, one or more elements of the infrastructure model to create a selection;
predicting, using a machine learning (ML) model in communication with the labeling tool, one or more additional elements that share similarities with the selected elements;
adding the one or more additional elements to the selection;
cycling through at least a set of the elements of the selection, the cycling to repeatedly present in the user interface an element or group of elements of the set of the elements and solicit user confirmation that the element or a group of elements belongs to a class or user input causing removal of the element a group of elements is from the selection;
assigning each element of the selection of the class; and
outputting each of the elements of the selection associated with the assigned class.

2. The method of claim 1, wherein the set of elements is less than all the elements of the selection, and the assigning assigns the class to both the set of the elements and remaining elements of the selection that were not part of the cycling.

3. The method of claim 1, further comprising:
grouping elements of the set of the elements based on one or more predefined rules that place elements that share characteristics within a same group.

4. The method of claim 3, wherein the same characteristics include a value of a metadata field, a polygon mesh that is same or within a predetermined threshold of difference, or a bounding box that is same or within a predetermined threshold of difference.

5. The method of claim 1, wherein the cycling cycles through each element or group of elements of the set sequentially, periodically, or randomly.

6. The method of claim 1, further comprising:
computing, using Bayesian inference, a probability that remaining elements of the selection that were not part of the set subject to the cycling belong to the class; and
displaying an indication of the probability in the user interface.

7. The method of claim 1, further comprising:
predicting, using the ML model, the class of the element or the group of elements.

8. The method of claim 7, wherein the outputting outputs a label file that includes each of the elements of the selection associated with the assigned class, the label file is usable to train a new ML model, and the selecting, predicting one or more additional elements, predicting the class, cycling, assigning and outputting are repeated using the new ML model.

9. The method of claim 1, further comprising:
loading, by the labeling tool, a prediction file that includes an ML prediction of classes of elements in the infrastructure model;
loading, by the labeling tool, the label file;
displaying, in a user interface of the labeling tool, a visualization of the infrastructure model, indications of numbers of elements for one or more classes included in the prediction file, and numbers of elements for one or more classes included in the label file; and
updating the displayed indications of numbers of elements for each class based on changes made in the assigning.

10. A method for labeling elements of an infrastructure model with classes, comprising:
loading, by a labeling tool executing on one or more computing devices, a label file that, when complete, includes classes of elements in the infrastructure model usable as ground truth to train a machine learning (ML) model;
loading, by the labeling tool, a prediction file that includes an ML model's predictions of classes of elements in the infrastructure model;
displaying, in a user interface of the labeling tool, a visualization of the infrastructure model, indications of numbers of elements for one or more classes included in the label file, and indications of numbers of elements for one or more classes included in the prediction file;
selecting, in response to user input in the user interface, an element of the infrastructure model;
assigning to the selected element or a group of elements that includes the selected element, a class;
updating the displayed indications of numbers of elements for each class based on changes made in the assigning; and
outputting a label file that includes the changes made in the assigning.

11. The method of claim 10, further comprising:
loading, by the labeling tool, a label definition file,
wherein each class is included in the label file, and each class included in the prediction file is a class defined in the label definition file.

12. The method of claim 10, wherein the label file is initially empty or is set to include ML model predicted classes from the prediction file.

13. The method of claim 10, further comprising:
selecting, in response to user input in the user interface, the label file or the prediction file,
wherein the displaying displays the visualization of the infrastructure model with visual indicia indicating classes included in the selected file.

14. The method of claim 13, wherein the visual indicia is color coding on elements.

15. The method of claim 10, wherein the displaying displays the visualization of the infrastructure model with at least one of:
color coding indicating a class hierarchy included in the label file or the prediction file;
color coding indicating confidence in prediction of a class included in the prediction file; or
color coding indicating differences in class between the label file and the prediction file.

16. A non-transitory electronic-device readable media having instructions stored thereon that, when executed on one or more processors of one or more electronic devices, are operable to:
display a visualization of an infrastructure model;
select one or more elements of the infrastructure model to create a selection;
predict, using a machine learning (ML) model, one or more additional elements that share similarities with the selected elements;
add the one or more additional elements to the selection;
cycle through at least a set of the elements of the selection to repeatedly present an element or group of elements of the set of the elements and solicit user confirmation that the element or group of elements belongs to a class or user input causing removal of the element or group of elements from the selection;
assign each element of the selection the class; and
output each of the elements of the selection associated with the assigned class.

17. The non-transitory electronic-device readable media of claim 16, wherein the set of elements is less than all the elements of the selection, and the instructions, when executed, assign the class to both the set of the elements and remaining elements of the selection that were not part of the cycling.

18. The non-transitory electronic-device readable media of claim 16, wherein the instructions, when executed, are further operable to:
group elements of the set of the elements based on one or more predefined rules that place elements that share characteristics within a same group.

19. The non-transitory electronic-device readable media of claim 16, wherein the instructions, when executed, cycle through each element or group of elements of the set sequentially, periodically, or randomly.

20. The non-transitory electronic-device readable media of claim 16, wherein the instructions, when executed, are further operable to:
compute, using Bayesian inference, a probability that remaining elements of the selection that were not part of the set subject to the cycling belong to the class; and
display an indication of the probability.
